(19) United States
(12) Patent Application Publication
(10) Pub. No.: US 2014/0190358 A1
(43) Pub. Date: Jul. 10, 2014

(54) FLATWARE ITEM FOR THERMALLY MELTING FOOD PRODUCT

(71) Applicant: CHAUN-CHOUNG TECHNOLOGY CORP., New Taipei City (TW)

(72) Inventors: Cheng-Tu WANG, NEW TAIPEI CITY (TW); Pang-Hung LIAO, NEW TAIPEI CITY (TW)

(73) Assignee: CHAUN-CHOUNG TECHNOLOGY CORP., NEW TAIPEI CITY (TW)

(21) Appl. No.: 13/738,169

(22) Filed: Jan. 10, 2013

(51) Int. Cl. A47G 21/00; A47G 21/04; A47J 43/28; B26B 3/02

(52) U.S. Cl. CPC A47G 21/00; B26B 3/02; A47G 21/04; A47J 43/282
USPC 99/483

(57) ABSTRACT

A flatware item for thermally melting a food product includes a metal body (10), a low-temperature-evaporable circulation fluid (20), and a reflux medium (30). The metal body (10) has a vacuum chamber (100), a hand holding portion (11), and a food contacting portion (12). The circulation fluid (20) is filled in the vacuum chamber (100), whereby the circulation fluid (20) absorbs external energy through the hand holding portion (11) and vaporizes, and the vaporized circulation fluid (20) flows to the food contacting portion (12). The reflux medium (30) is spread on the inner wall of the vacuum chamber (100).

### BACKGROUND OF THE INVENTION

1. Field of the Invention

The present invention relates to a flatware item and in particular to a flatware item for thermally melting a food product.

2. Description of Related Art

Flatware is a necessary eating and drinking utensil when people enjoy the food product. Particularly, in the circumstances of a considerable amount of the food product such as a bucket of ice cream and a whole block of butter or cheese which needs to be scooped or cut many times, a flatware item such as an ice cream scoop or a butter knife is required for people to distribute and take the food product.

However, the above-mentioned food product such as ice cream, butter, or cheese is usually taken out from the refrigerator or freezer compartment and such a cold hard food product just leaving the refrigerator is not easy to be cut and spread. When people want to taste the food product, they have to hold the flatware such as an ice cream scoop or a butter knife with one hand and try to apply a force to scoop or cut the food product. That is time-consuming and laborious and the resulting appearance of the scooped or cut food is less appealing.

Moreover, people may place the food product such as ice cream, butter, or cheese at room temperature for a while to let it melt slowly and then taste. However, such a treatment is inconvenient for the subsequent preservation of the remains of the food products and easily spoils the freshness and flavor thereof, causing the inconvenience of use and not satisfying people's requirement.

Accordingly, in order to overcome the above drawbacks, the inventor proposes the invention which is designed reasonably and effectively overcome the above drawbacks after a substantially devoted study in cooperation with the application of academic principles.

### SUMMARY OF THE INVENTION

One objective of the present invention is to provide a flatware item for thermally melting a food product which allows the body heat from the user to be conducted from the hand holding portion to the food contacting portion to melt the food product when the user holds the flatware item and thus facilitate the cutting.

In order to achieve the above objective, the present invention provides a flatware item for thermally melting a food product, including a metal body, a low-temperature-evaporable circulation fluid, and a reflux medium. The metal body has a vacuum chamber, one end of the metal body forming a hand holding portion and the other end of the metal body forming a food contacting portion, the interiors of the hand holding portion and the food contacting portion communicating with the vacuum chamber. The circulation fluid is filled in the vacuum chamber, whereby the circulation fluid absorbs external energy through the hand holding portion and vaporizes, and the vaporized circulation fluid flows to the food contacting portion and releases the energy to melt the food product. The reflux medium is spread on the inner wall of the vacuum chamber, whereby the circulation fluid flows back to the hand holding portion through the reflux medium after the circulation fluid releases the energy.

Another objective of the present invention is to provide a flatware item for thermally melting a food product which can be applied to the flatware such as a butter knife, a table knife to heat or thermally melt the food held by the flatware or the food to be cut.

Compared with the related art, the flatware item for thermally melting a food product of the present invention has a hollow chamber which is filled with a low-temperature-evaporable circulation fluid. When the user holds one end of the flatware item (i.e., the hand holding portion), the circulation fluid absorbs the body heat from the user and vaporizes to quickly conduct the heat energy to the other end of the flatware item (i.e., the food contacting portion) and then releases the heat energy to heat the food product at the other end. Due to the vaporization of the circulation fluid being used in the present invention to conduct the heat energy within the vacuum chamber, the present invention can accelerate the energy conduction, heat the food product immediately, and thus enhance the convenience of use.

### BRIEF DESCRIPTION OF DRAWING

FIG. 1 is a perspective view of the flatware item for thermally melting a food product according to a preferred embodiment of the present invention;

FIG. 2 is a cross-sectional view of the flatware item for thermally melting a food product according to a preferred embodiment of the present invention;

FIG. 3 is another embodiment of the flatware item for thermally melting a food product of the present invention;

FIG. 4 is a further embodiment of the flatware item for thermally melting a food product of the present invention;

FIG. 5 is a yet further embodiment of the flatware item for thermally melting a food product of the present invention; and

FIG. 6 is a schematic of the flatware item for thermally melting a food product of the present invention in operation.

### DETAILED DESCRIPTION OF THE INVENTION

The detailed description and technology of the present invention will be described as follows with figures and description. However, the accompanying figures are provided only for reference and explanation, but not for limiting the present invention

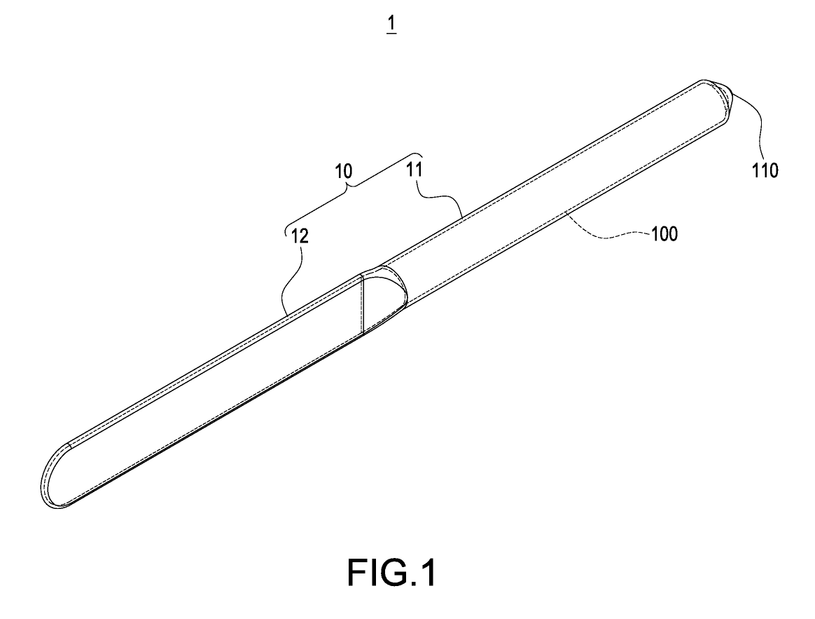

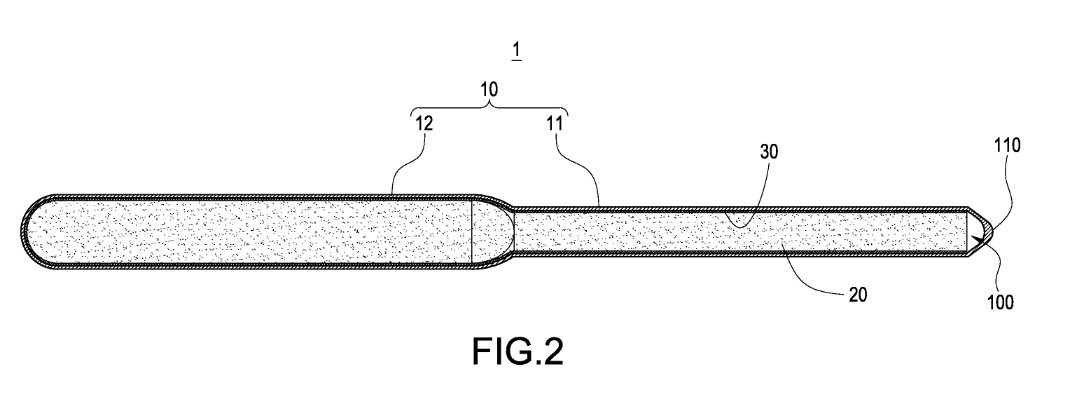

Please refer to FIGS. 1 and 2 which are the perspective view and cross-sectional view of the flatware item for thermally melting a food product according to a preferred embodiment of the present invention, respectively. The present invention is a flatware item 1 for thermally melting a food product, including a metal body 10, a low-temperature-evaporable circulation fluid 20, and a reflux medium 30. The circulation fluid 20 and the reflux medium 30 are disposed in the metal body 10 to form the flatware item 1.

The metal body 10 can be made of copper or aluminum. The metal body 10 has a vacuum chamber 100. The vacuum chamber 100 is a chamber in a vacuum state which can assists the vapor in quick energy conduction. One end of the metal body 10 forms a hand holding portion 11 (for the user's handling) and the other end thereof forms a food contacting portion 12 (the portion contacting the food product). Besides, the interiors of the hand holding portion 11 and the food contacting portion 12 communicates with the vacuum chamber 100. In an embodiment of the present invention, one end of the chamber vacuum 101 is the hand holding portion 11 and the other end thereof is the food contacting portion 12.

The low-temperature-evaporable circulation fluid 20 is filled in the vacuum chamber 100. The circulation fluid 20 absorbs external energy through the hand holding portion 11 and vaporizes. Because the circulation fluid 20 can be vaporized at a lower temperature, the circulation fluid 20 can absorb the external heat (i.e., the body heat of the holder). The vaporized circulation fluid 20 then flows to the food contacting portion 12 and releases the energy to melt the food product.

The circulation fluid 20 is a fluid with a low vaporization temperature. Preferably, the circulation fluid 20 is water or alcohol. In practical operation, the circulation fluid 20 is in a liquid state at a lower temperature; on the other hand, the circulation fluid 20 absorbs heat and vaporizes at a higher temperature.

For example, the circulation fluid 20 originally disposed in the vacuum chamber 100 is liquid and when the user holds the hand holding portion 11 of the flatware item 1, the circulation fluid 20 in the hand holding portion 11 absorbs the body heat of the user and then vaporizes. Then, the vaporized circulation fluid 20 flows to the food contacting portion 12 which is at a lower temperature. Finally, the vaporized circulation fluid 20 releases the heat energy at the food contacting portion 12 and transforms into the liquid circulation fluid 20, in which the released energy is to thermally melt the food product.

The reflux medium 30 is stainless steel wire, copper wire or other metal net. The reflux medium 30 is spread on the inner wall of the vacuum chamber 100. The circulation fluid 20 finally releasing the energy at the food contacting portion 12 flows back to the hand holding portion 11 by means of the reflux medium 30. In more detail, when the circulation fluid 20 releases the energy at the food contacting portion 12 and transforms back to liquid, the liquid circulation fluid 20 at this moment will flow back to the hand holding portion 11 along the inner wall of the vacuum chamber 100 by means of the reflux medium 30.

In an embodiment of the present invention, the flatware item 1 is a butter knife. The hand holding portion 11 has a seal 110. The circulation fluid 20 is filled into the vacuum chamber 100 through the seal 110.

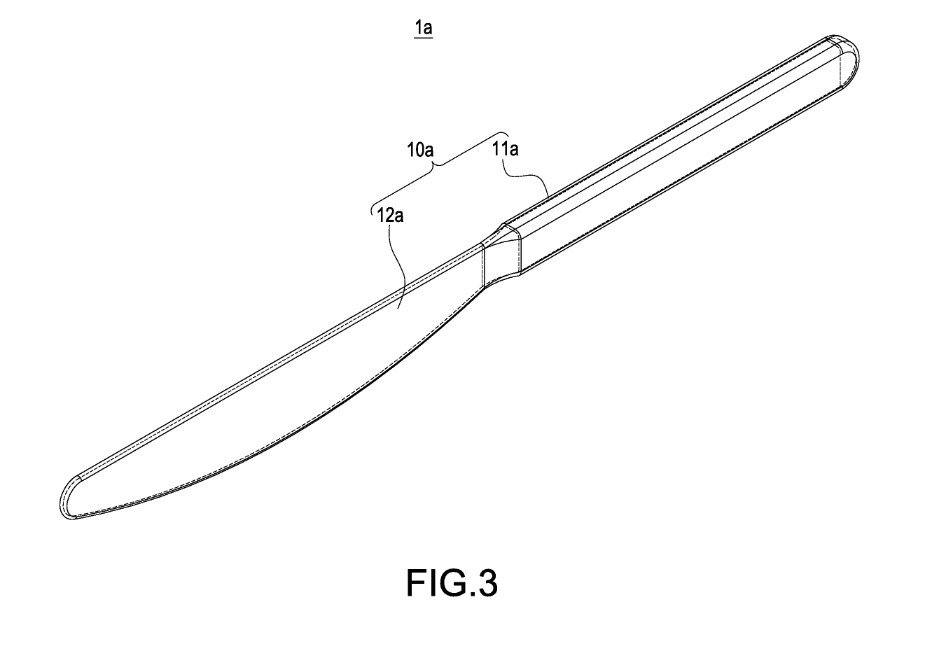

Please continue to refer to FIGS. 3-5, which are three embodiments of the flatware item for thermally melting a food product of the present invention. In FIG. 3, the flatware item 1a is a table knife and the metal body 10a has a knife shape. The hand holding portion 11a is a knife handle for the user's holding. The food contacting portion 12a is a blade to cut the food product.

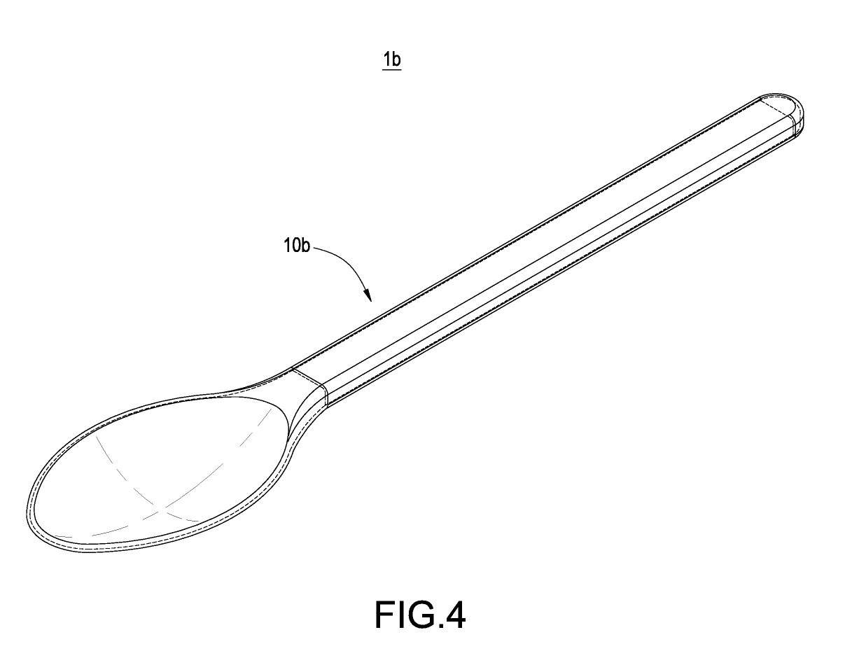

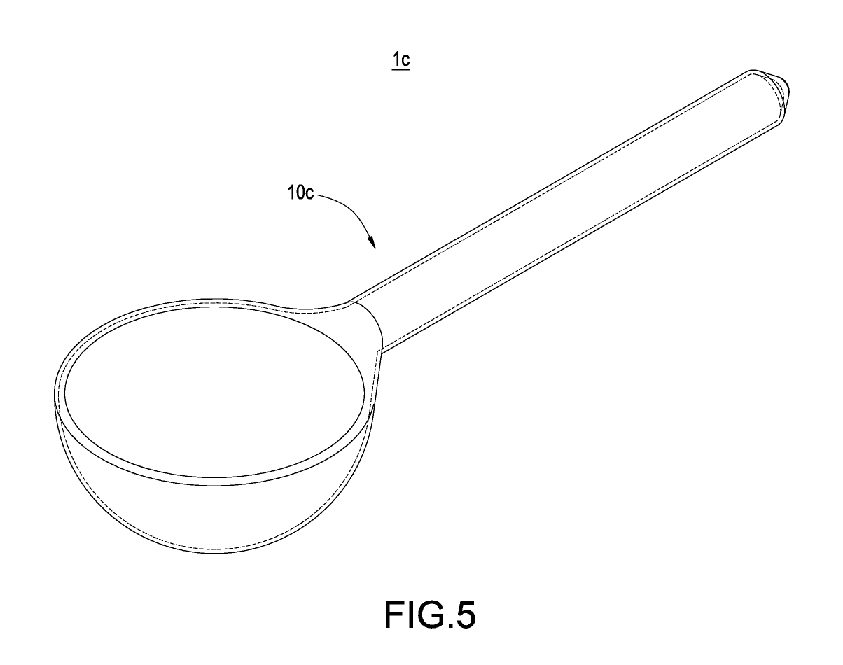

As shown in FIG. 4, the metal body 10b of the flatware item 1b has a spoon shape to ladle soup or other liquid. Referring to FIG. 5, the metal body 10c of the flatware item 1c has a shape of an ice cream scoop for the user to scoop ice cream.

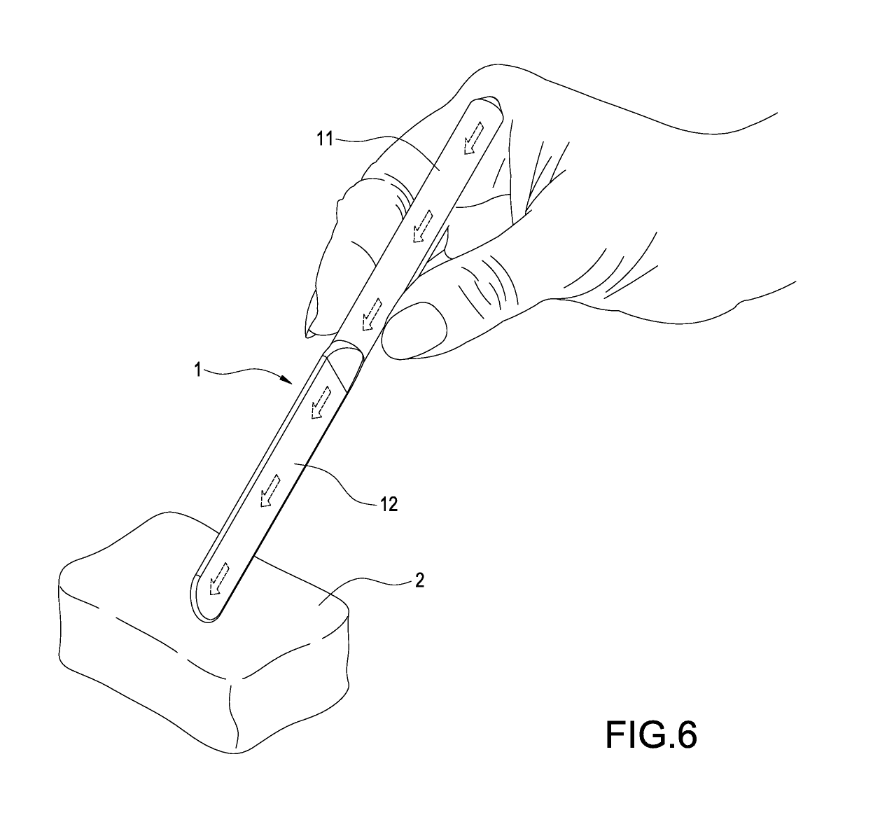

Please refer to FIG. 6, which is a schematic of the flatware item for thermally melting a food product of the present invention in operation. FIG. 6 shows the schematic of the user's holding the flatware item 1 (butter knife) to cut a butter block 2. When the user holds the hand holding portion 11 of the flatware item 1, the circulation fluid 20 in the hand holding portion 11 absorbs the body heat of the user and then vaporizes. After the circulation fluid 20 absorbs the external energy, it vaporizes immediately. The vaporized vapor in the vacuum chamber 100 will flow to the food contacting portion 12; that is, the energy is conducted from the hand holding portion 11 to the food contacting portion 12.

Due to the low vaporization temperature of the circulation fluid 20 of the present invention and the vacuum chamber inside the flatware item, the circulation fluid 20 can flow quickly and conduct energy. The vaporized circulation fluid 20 in the vacuum chamber 100 will flow to the food contacting portion 12 at a lower temperature and release the energy at the food contacting portion 12 to increase the temperature of the food contacting portion 12. When the food contacting portion 12 of higher temperature contacts the butter block 2, the butter block 2 is melted immediately to make the user easily cut the butter block 2.

Finally, the circulation fluid 20 which has released the energy transforms back to liquid and flows back to the hand holding portion 11 along the inner wall of the vacuum chamber 100 through the reflux medium 30; thus, the circulation fluid 20 is used repeatedly in the vacuum chamber 100. By means of the flatware item 1, part of the body heat of the user is conducted from the hand holding portion 11 of the flatware item 1 to the food contacting portion 12, as an energy source to melt the food product.

The above description is only the preferred embodiments of the present invention and it will be understood that the above embodiments are not to limit the scope of the present invention. Other equivalent variations and equivalent modifications according to the spirit of the present invention are also embraced within the scope of the present invention as defined in the appended claims.

What is claimed is:

1. A flatware item for thermally melting a food product, including:
a metal body (10) having a vacuum chamber (100), one end of the metal body (10) forming a hand holding portion (11) and the other end of the metal body (10) forming a food contacting portion (12), an interior of the hand holding portion (11) and the food contacting portion (12) communicating with the vacuum chamber (100);
a low-temperature-evaporable circulation fluid (20) filled in the vacuum chamber (100), whereby the circulation fluid (20) absorbs external energy through the hand holding portion (11) and vaporizes, and the vaporized circulation fluid (20) flows to the food contacting portion (12) and releases the energy to thermally melt the food product; and
a reflux medium (30) spread on an inner wall of the vacuum chamber (100), whereby the circulation fluid (20) flows back to the hand holding portion (11) through the reflux medium (30) after the circulation fluid (20) releases the energy.

2. The flatware item according to claim 1, wherein the metal body (10) is made of stainless steel or copper.

3. The flatware item according to claim 1, wherein the hand holding portion (11) have a seal (110) and the circulation fluid (20) is filled into the vacuum chamber (100) through the seal (110).

4. The flatware item according to claim 1, wherein the reflux medium (30) is stainless steel wire, copper wire or other metal net.

5. The flatware item according to claim 1, wherein the metal body (10) has a knife shape.

6. The flatware item according to claim 5, wherein the hand holding portion (11) is a knife handle and the food contacting portion (12) is a blade.

7. The flatware item according to claim 1, wherein the metal body (10) has a spoon shape.

8. The flatware item according to claim 1, wherein the metal body (10) has a shape of an ice cream scoop.

9. The flatware item according to claim 1, wherein the circulation fluid (20) is water or alcohol.
